(19) United States
(12) Patent Application Publication
(10) Pub. No.: US 2009/0188988 A1
(43) Pub. Date: Jul. 30, 2009

(54) SPRAY NOZZLE WITH INVERTED FLUID FLOW AND METHOD

(75) Inventors: Samuel C. Walker, Green Valley, AZ (US); Rowshan Jahan, Tucson, AZ (US)

Correspondence Address: FITCH EVEN TABIN & FLANNERY, 120 SOUTH LASALLE STREET, SUITE 1600, CHICAGO, IL, 60603-3406, US

(73) Assignee: Rain Bird Corporation, Azusa, CA (US)

(21) Appl. No.: 12/418,057

(22) Filed: Apr. 3, 2009

Related U.S. Application Data
(63) Continuation-in-part of application No. 11/674,434, filed on Feb. 13, 2007.

(51) Int. Cl. B05B 17/00; B05B 1/26

(52) U.S. Cl. 239/8; 239/520

(57) ABSTRACT

A spray nozzle and method are provided in which fluid flow through the nozzle is inverted and in which a portion of a nozzle body may be rotatable adjusted to distribute water in a desired arc of coverage. Water first flows upwardly through the nozzle body, into an adjustable arcuate chamber defined by a helical interface in the nozzle body, is inverted, and is redirected downwardly through the nozzle body. Water may flow upwardly through a first set of flow passages and downwardly through a second set of flow passages. Water is directed downwardly against a distribution surface having an uneven surface profile for improved water distribution to terrain near to and distant from the nozzle. The water is directed downwardly against the distribution surface in the nozzle body and outwardly to surrounding terrain. The flow passages may be adapted to provide a matched precipitation rate for nozzles with different throw radiuses.

### CROSS REFERENCE TO RELATED APPLICATION

This application is a continuation-in-part of pending U.S. patent application Ser. No. 11/674,434, filed Feb. 13, 2007, which is incorporated herein by reference in its entirety.

### FIELD OF THE INVENTION

This invention relates to an irrigation spray nozzle and method and, more particularly, to a nozzle with an inverted fluid flow and that is adjustable to allow irrigation through a desired fluid distribution arc.

### BACKGROUND OF THE INVENTION

Irrigation nozzles have been adapted for mounting on a fixed or pop-up water supply riser. Spray type irrigation nozzles typically include at least one discharge orifice shaped to distribute fluid in a stream or spray pattern of a pre-selected arcuate span. One common form of such spray nozzle includes an upper deflector assembled to a lower nozzle body designed for mounting onto the riser. The deflector and nozzle body cooperatively define the discharge orifice with the selected arcuate span through which fluid is projected from the nozzle. Such spray nozzles commonly include a series of models that each produce a different spray pattern, such as, for example, a quarter-circle, half-circle, and full-circle spray pattern.

One shortcoming of many commercially available spray nozzles is their tendency to distribute fluid in a doughnut-shaped watering pattern caused by less fluid being distributed in the regions relatively close to and distant from the nozzle. In other words, such spray nozzles distribute most of the fluid to a mid-range region from the nozzle. This limited fluid distribution results from the spatial arrangement between the upper deflector and the lower nozzle body. More specifically, it arises because fluid is directed upwardly from the lower nozzle body to impact the upper deflector, which then redirects the fluid to the surrounding terrain. In such commercially available spray nozzles, the fluid stream is generally comprised of two portions: an upper portion and a lower portion. The upper portion of the stream typically has a relatively low velocity because it has experienced frictional drag across the deflector. In contrast, the lower portion of the stream generally has a relatively high velocity because it has not experienced this frictional drag. As both fluid stream portions are emitted outwardly, gravity causes the lower velocity fluid to interfere with the higher velocity fluid, resulting in an intermediate velocity fluid stream that irrigates with only a mid-range doughnut pattern about the nozzle.

Accordingly, there is a need for a spray nozzle that reduces interference between low velocity and high velocity portions of the fluid stream. This would provide an enhanced distribution pattern by increasing the amount of fluid distributed to terrain outside of the limited mid-range distance, i.e., to terrain relatively near to, as well as terrain relatively distant from, the nozzle. One approach for reducing this interference is through the inversion of fluid flowing through the spray nozzle, which, in effect, switches the spatial arrangement of the low velocity and high velocity portions.

It would be desirable to have an inverted flow spray nozzle that is not a fixed arc nozzle but that can instead be adjusted to a desired variable fluid distribution arc. In this regard, it is desirable that the spray nozzle have the capability of distributing fluid through virtually infinite arcuate settings along a continuum between a full circle open setting and a very small arcuate closed setting. There is therefore a need for a spray nozzle having both an inverted fluid flow capability for more uniform fluid distribution and having an adjustable arc capability.

It would also be desirable to have a spray nozzle capable of distributing fluid at a constant precipitation rate regardless of the size of the fluid distribution arc selected by a user. Thus, there is a need for a variable arc nozzle that proportionally adjusts the flow rate through the nozzle as the arcuate span of the fluid distribution is adjusted by the user. Otherwise, there will be an uneven fluid distribution rate, i.e., a different volume per area depending on the arc setting.

Further, spray nozzles are often designed as part of a family of nozzles in which each nozzle has a different intended maximum throw radius. For example, nozzles may be individually designed to have throw radiuses of 4, 6, 8, 10, 12, and 15 feet. It would be desirable to have a spray nozzle in which the precipitation rate of each type of nozzle can be “matched” to the precipitation rates of the other types of nozzles. Accordingly, there is a need for a spray nozzle that incorporates at least all of these features: (1) inversion of fluid flow to reduce interference between high and low velocity fluid streams; (2) variable arc capability to allow the spray nozzle to be set to a desired fluid distribution arc; (3) a relatively uniform precipitation rate regardless of the size of the arc selected by the user; and (4) the ability to match the precipitation rate for nozzles of a nozzle family in which each nozzle has a different maximum throw radius.

### BRIEF DESCRIPTION OF THE DRAWINGS

FIG. 1 is a perspective view of a spray nozzle embodying features of the present invention;

FIG. 2 is a cross-sectional view of the spray nozzle of FIG. 1;

FIG. 3 is a top exploded view of the spray nozzle of FIG. 1;

FIG. 4 is a bottom exploded view of the spray nozzle of FIG. 1;

FIG. 5 is a perspective view of a base of the spray nozzle of FIG. 1;

FIG. 6 is cross-sectional view of the base of FIG. 5;

FIG. 7 is a perspective view of a first embodiment of a collar of the spray nozzle of FIG. 1;

FIG. 8 is a cross-sectional view of the collar of FIG. 7;

FIG. 9 is a top view of the collar of FIG. 7;

FIG. 10 is a side elevational view of the collar of FIG. 7;

FIG. 11 is a perspective view of a first embodiment of a deflector of the spray nozzle of FIG. 1;

FIG. 12 is a cross-sectional view of the deflector of FIG. 11;

FIG. 13 is a side elevational view of the deflector of FIG. 11;

FIG. 14 is a bottom view of the deflector of FIG. 11;

FIG. 15 is a perspective view of a second embodiment of a collar;

FIG. 16 is a side elevational view of the collar of FIG. 15;

FIG. 17 is a cross-sectional view of the collar of FIG. 15;

FIG. 18 is a perspective view of a third embodiment of a collar;

FIG. 19 is an enlarged perspective view of a distribution surface of the collar of FIG. 18;

FIG. 20 is a perspective view of a fourth embodiment of a collar;

FIG. 21 is a top view of the collar of FIG. 20;

FIG. 22 is a perspective view of a fifth embodiment of a collar;

FIG. 23 is a perspective view of a sixth embodiment of a collar;

FIG. 24 is an enlarged partial view of the collar of FIG. 23;

FIG. 25 is a perspective view of a second embodiment of a deflector;

FIG. 26 is a cross-sectional view of the deflector of FIG. 25;

FIG. 27 is a side elevational view of a third embodiment of a deflector; and

FIG. 28 is a cross-sectional view of the deflector of FIG. 27.

### DESCRIPTION OF THE PREFERRED EMBODIMENTS

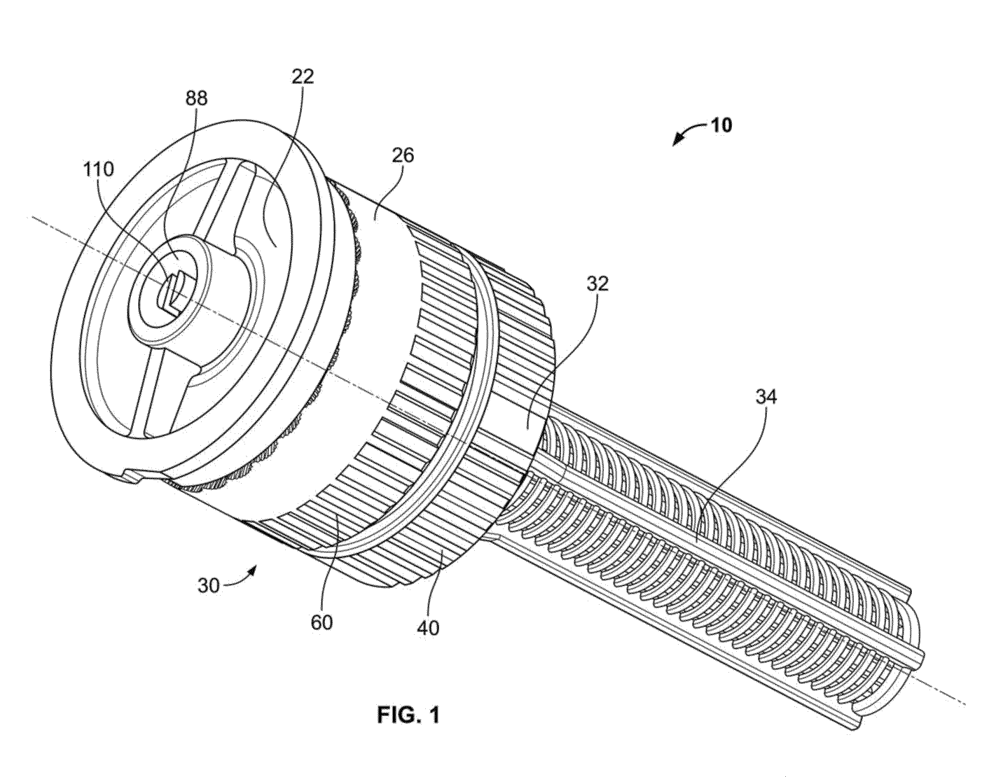

As can be seen in FIGS. 1-4, there is illustrated a preferred embodiment of a spray nozzle 10 embodying features of the present invention. As can be seen in FIGS. 1-4, the spray nozzle 10 provides for the inversion of fluid flow to reduce interference between high and low velocity fluid streams and provides for variable arc capability to allow the spray nozzle to be set to a desired fluid distribution arc. In addition, as described further below, the spray nozzle 10 has a relatively uniform throw radius, regardless of the arc setting selected by the user, and may be easily adapted to provide a matched precipitation rate for nozzles having different maximum throw radiuses.

In the preferred embodiments, the nozzle 10 inverts fluid flow. The nozzle 10 improves the flow pattern at the inner and outer regions of the spray coverage by using a downward flow directed downwardly at distribution surfaces 12 of the nozzle 10, in contrast to upward flow directed upwardly to impact against an upper deflector (as used in conventional spray nozzles). The inverted nature of the downward flow onto the distribution surfaces 12 results in a more uniform distribution of fluid, when compared to an upward flow directed upwardly against an upper deflector, because the lower flow velocity component of the fluid discharging from the nozzle 10 does not interfere directly with or fall into the higher velocity component, or provides relatively minimal interference.

In other words, the low velocity component of the fluid flow is at the bottom portion of the discharging fluid, and the higher velocity component sprays generally above the lower velocity component. Consequently, the higher velocity component provides both a longer throw, which increases the watering area, and an improved watering at the outer region, and the lower velocity component waters the inner region more effectively.

In the preferred embodiment, the inverted fluid flow is created by first directing the supply water upwardly toward the deflector of the nozzle 10 in a direction parallel to the central axis and then reversing the flow in the opposite direction down onto the distribution surfaces 12. In one preferred form, a plurality of upward flow passages 14 are used to direct the fluid initially upwardly to a helical interface 16, which forms one helical revolution. The fluid then flows through the arcuate chamber 18 and then downwardly through a series of downward flow passages 20 onto the distribution surfaces 12 to be redirected outwardly from the nozzle 10 for irrigation.

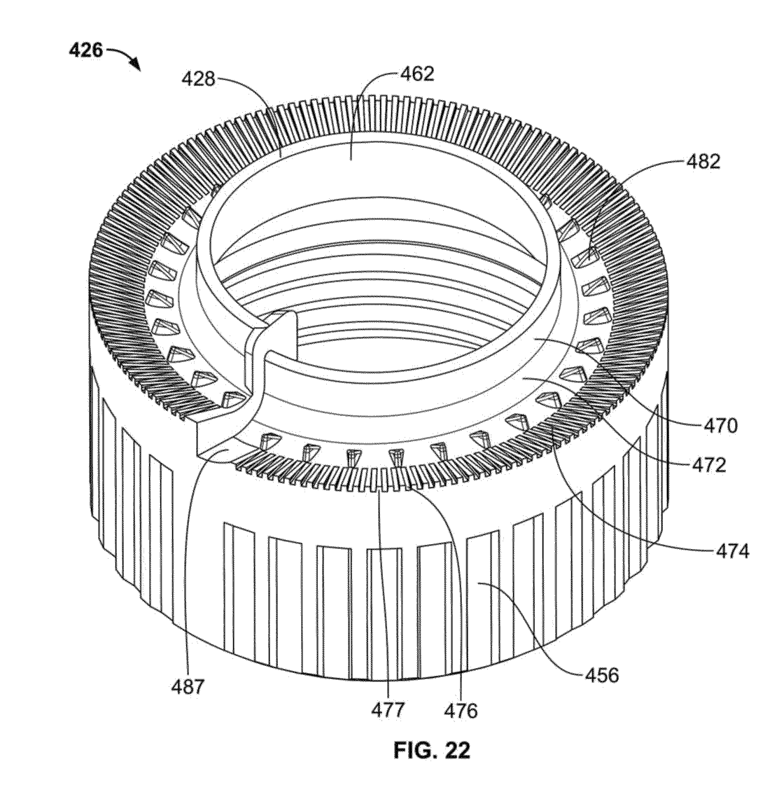

It should be understood, however, that the upward and downward flow passages 14 and 20 are not required. Preferred embodiments of nozzle portions are described herein, such as shown in FIGS. 22-28, that do not utilize upward and downward flow passages 14 and 20. In these preferred embodiments (as described further below), instead of flowing through the individual flow passages, fluid flows generally upwardly through a first open arcuate section of the deflector, is inverted, and then flows downwardly through a second open arcuate section of the collar. The use of upward flow passages 14 and/or downward flow passages 20 may be desirable for nozzles in a nozzle family having a relatively short throw radius, while the omission of upward flow passages 14, downward flow passages 20, or both may be desirable for nozzles in a nozzle family having a relatively long throw radius.

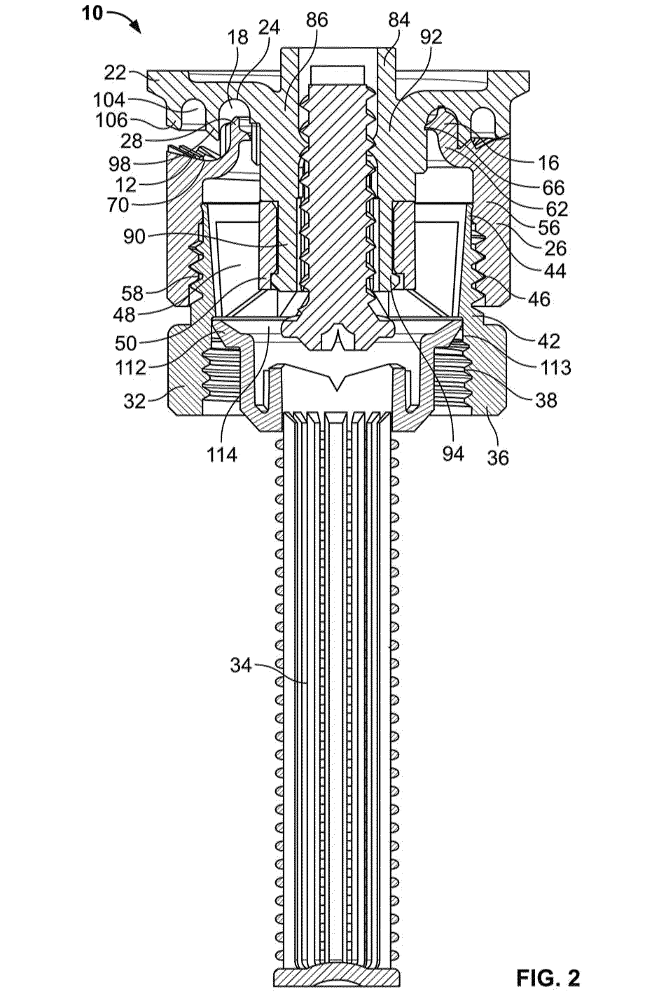

The nozzle 10 also preferably includes a variable arc capability. The nozzle 10 includes a first nozzle body portion 22 having a first downward-facing, helical surface 24 and a second nozzle body portion 26 having a second upward-facing, helical surface 28. The first nozzle portion 22 is fixed while the second nozzle portion 26 is rotatable. In a closed position, the first and second nozzle portions 22 and 26 sealingly engage one another to block fluid from flowing from the upward flow passages 14 to the downward flow passages 20 (with respect to preferred embodiments having flow passages). The second nozzle portion 26 may be rotated from the closed position to a desired arcuate setting. This rotation causes the helical interface 16 to open and allows fluid to flow from the upward flow passages 14 to the downward flow passages 20 within the selected fluid distribution arc. In other words, this rotation valves the upward and downward flow passages 14 and 20, i.e., opens a certain number of passages depending on the size of the water distribution arc selected. The remainder of the helical interface 16 remains closed. In FIG. 2, the left side of the figure shows an open portion and the right side shows a closed portion.

In one preferred embodiment, as shown in FIGS. 1-4, the nozzle 10 preferably includes upward and downward flow passages 14 and 20 that are helically spaced about the nozzle 10. These passages 14 and 20 proportion the upward and downward fluid flow, depending on the size of the fluid distribution arc. In addition, as explained further below, a matched precipitation rate can be achieved for different nozzle types by appropriately selecting the number and arrangement of the upward flow passages 14 with respect to the number and arrangement of the downward flow passages 20.

The nozzle 10 preferably includes a nozzle body 30 having a central axis and preferably includes three nozzle body portions 22, 26, and 32. In the first preferred form, the first (deflector), second (collar), and third (base) nozzle body portions 22, 26, and 32 define the upward and downward flow passages 14 and 20, the helical surfaces 24 and 28, and the helical interface 16. These components preferably are formed of a molded plastic material, or other suitable material, and although they are shown as three separate parts, they also may be combined to form one part or two parts. The nozzle 10 also preferably includes a filter 34 to screen out particulate matter and a screw 110 that helps retain the components together. The screw 110 may be an adjustable flow rate adjustment screw to regulate fluid flow through the nozzle 10.

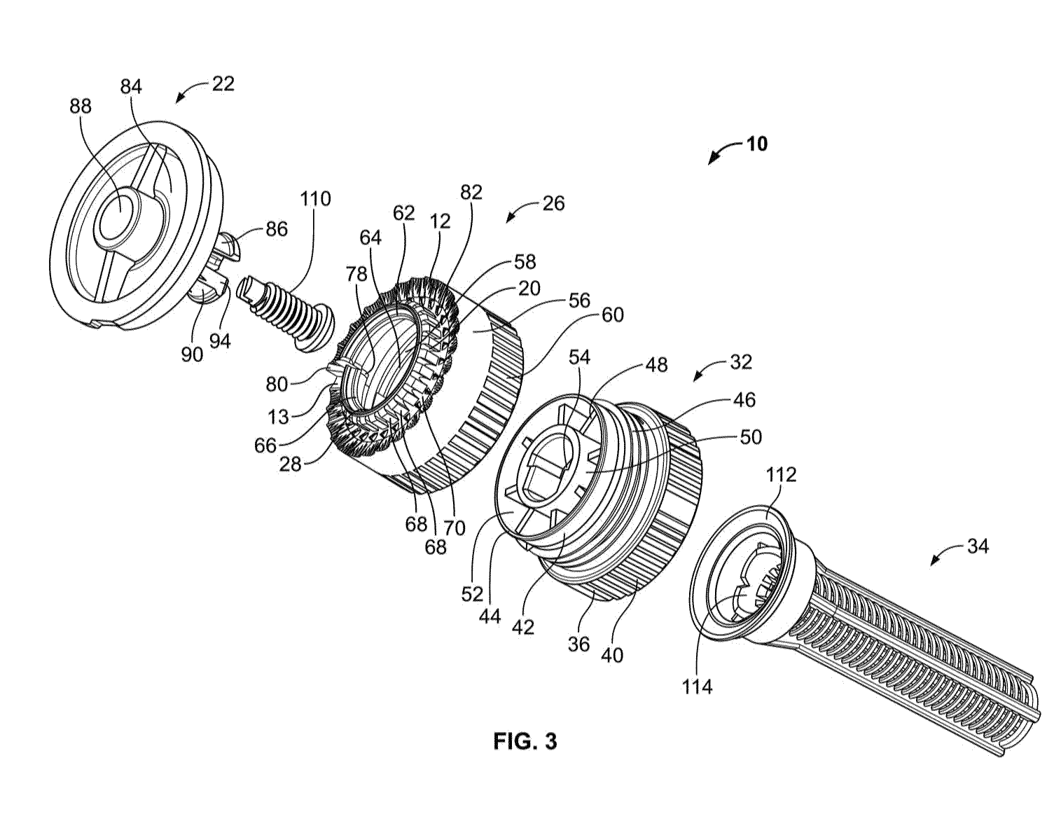

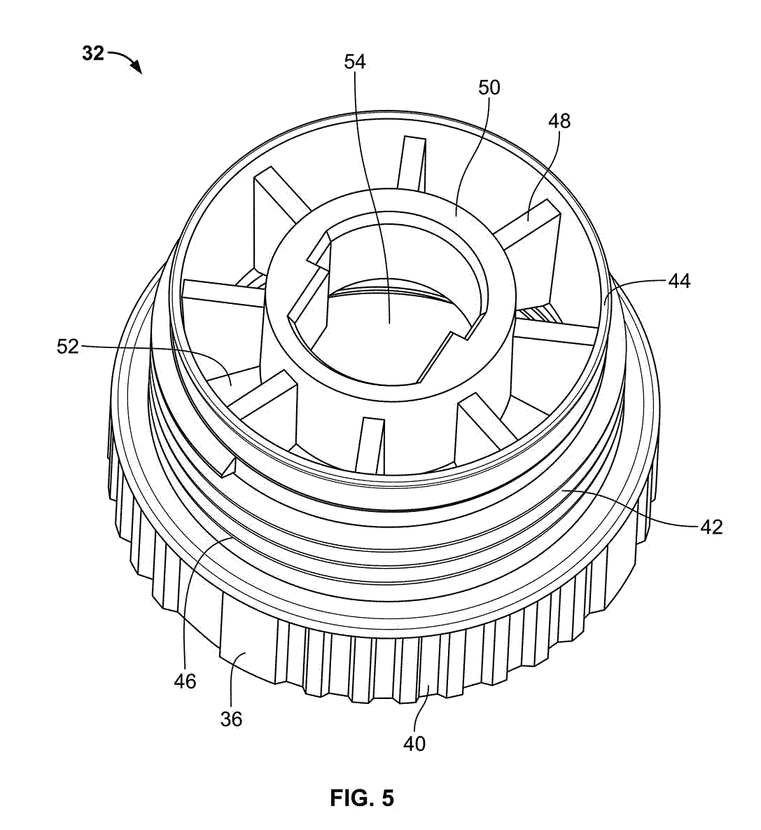

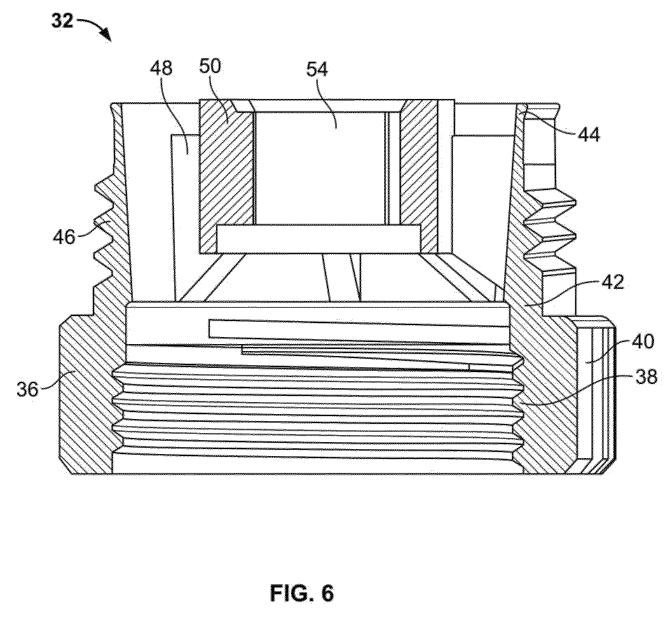

As shown in FIGS. 3-6, the base 32 has a generally cylindrical shape with a lower end 36 having internal threading 38 for thread-on mounting onto an upper end of a riser having complementary exterior threading (not shown). The lower end 36 also has a grippable external surface 40 (such as a knurled surface) to assist in holding and turning the base 32 for mounting onto the riser. An outer wall 42 extends upwardly from the lower end 36 and terminates in an upper cylindrical sealing lip 44. The outer wall 42 preferably includes external threading 46 for engagement with internal threading of the collar 26, as described below.

The base 32 further preferably includes a set of internal ribs 48 forming spokes that are located above the internal threading 38. The ribs 48 interconnect the outer wall 42 to a central hub 50 and define flow passages 52 therebetween that permit fluid flow upwardly through the base 32. The central hub 50 defines a key-shaped central bore 54 to accommodate fixed insertion of a corresponding stem portion of the deflector 22 therein. The central hub 50 holds the deflector 22 fixed against rotation.

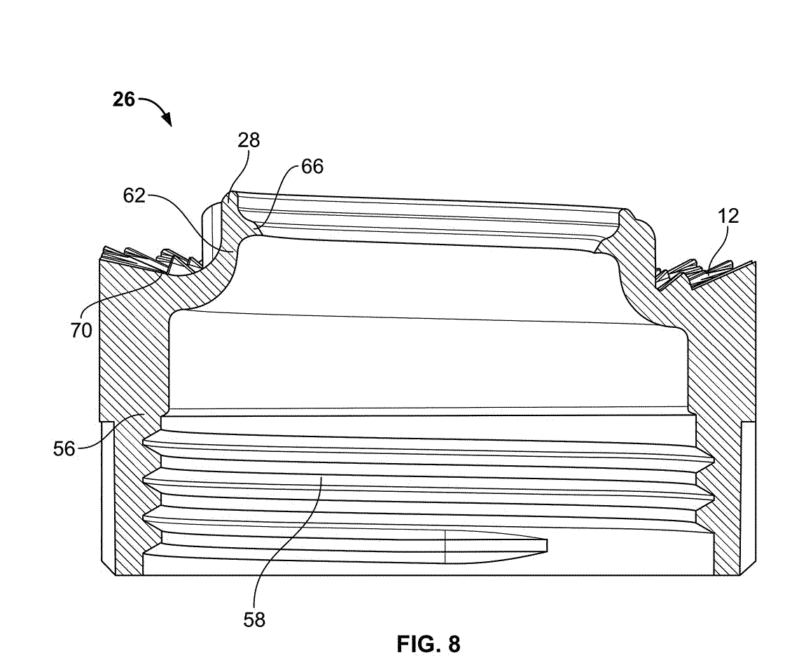

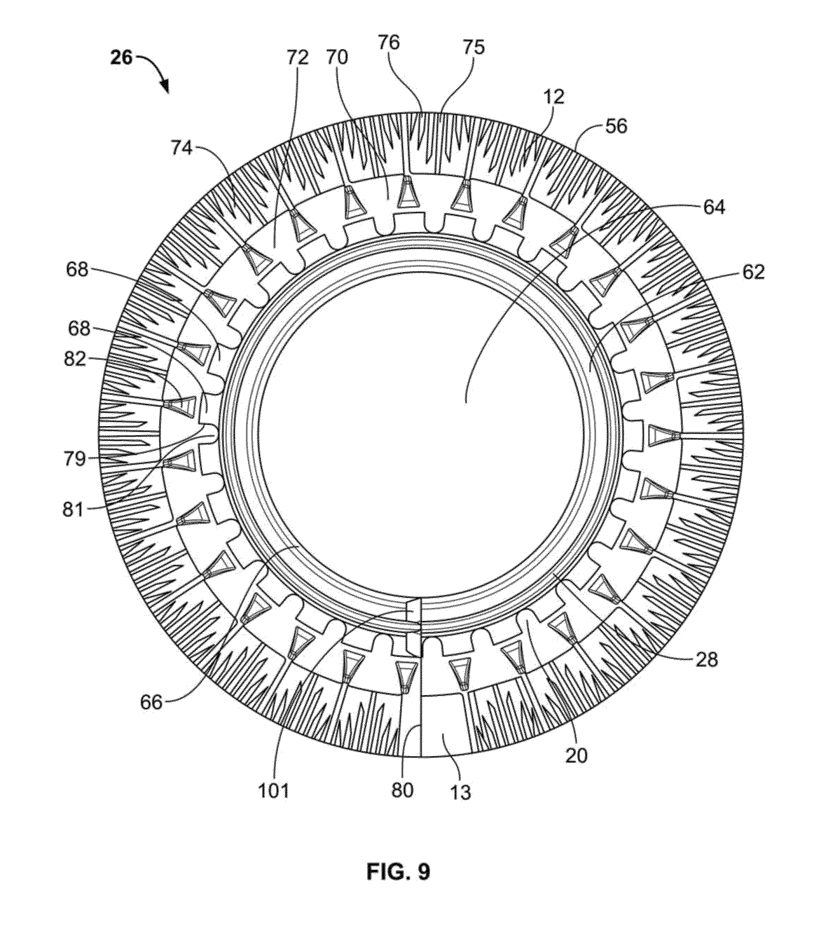

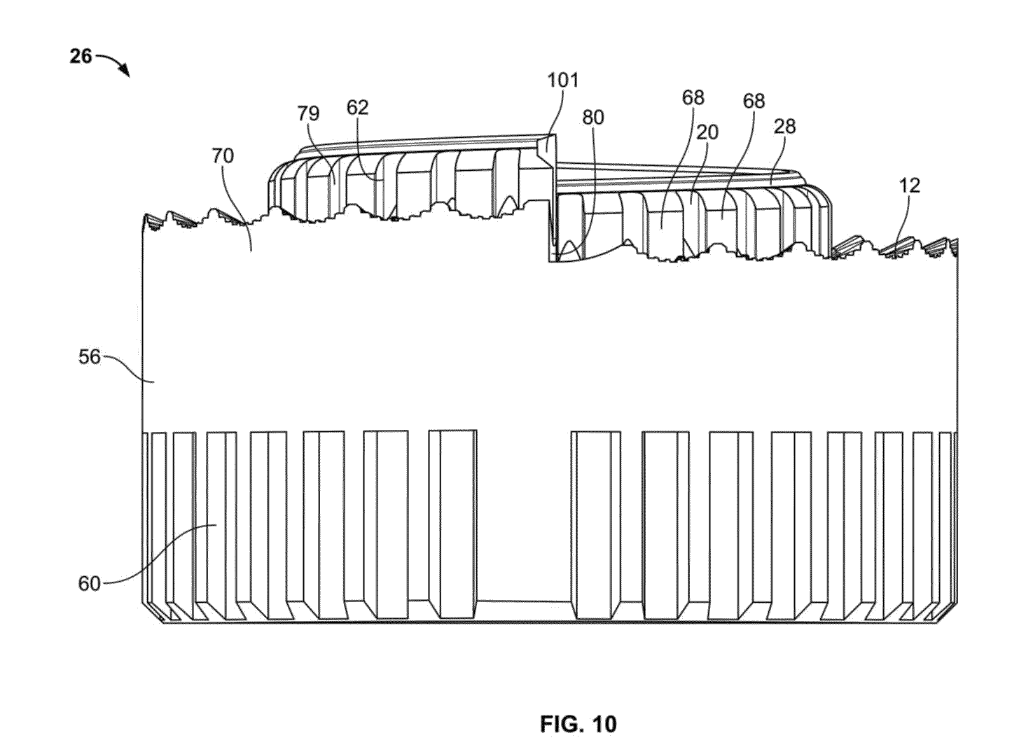

As shown in FIGS. 3, 4, and 7-10, the nozzle 10 also includes a first embodiment of a collar 26 that is generally cylindrical in shape and that is positioned between the base 32 and the deflector 22. The collar 26 includes an outer wall 56 with internal threading 58 at its lower end for rotatable engagement with the external threading 46 of the base 32. The collar 26 further preferably includes a gripping surface 60 on the exterior of the outer wall 56. This gripping surface 60 may be rotated by a user to set the nozzle 10 to the desired arcuate setting between a substantially closed position (0 degrees) and a fully open position (360 degrees).

The collar 26 includes a central hub 62 at its upper end that defines a central bore 64 therethrough. The central hub 62 forms an inner helical edge 66 and an upper helical edge 28. The inner helical edge 66 projects radially inwardly and engages the collar 26, as described further below, to block and unblock upward fluid flow through upward flow passages 14. The inner helical edge 66 sealingly engages the deflector 22 and may be rotatably adjusted for setting the desired fluid distribution arc. Rotation of the collar 26 blocks and unblocks the upward fluid flow.

The upper helical edge 28 projects upwardly and forms a top surface of the collar 26. It is preferably in the shape of a helical upward-facing, upward-sloping lip or ramp. The upper helical edge 28 defines the helical interface 16 in conjunction with the deflector 22, as described below. Rotation of the collar 26 forms an arcuate chamber 18 in the helical interface 16, thereby allowing fluid to flow from the upward flow passages 14 over the top of the upper helical edge 28 and to the downward flow passages 20. The upper helical edge 28 rotatably and sealingly engages the helical underside surface 24 of the deflector 22 to define the arcuate chamber 18 that is adjustable in size.

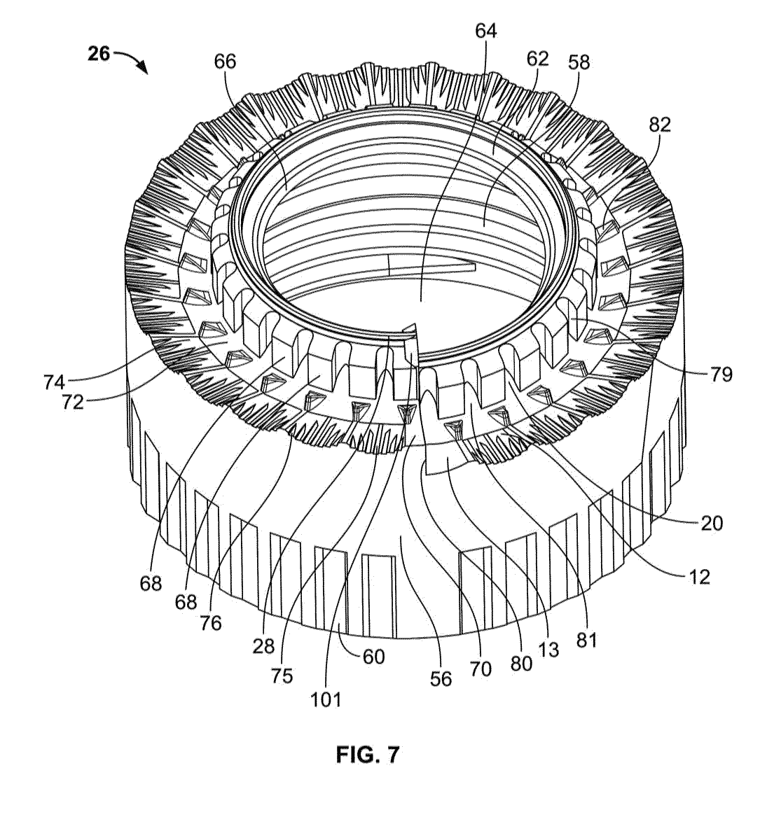

As shown in FIG. 7, in one preferred form, a plurality of downward flow passages 20 are formed on an outwardly-facing circumferential portion of the central hub 62. Each downward flow passage 20 is defined between two outwardly projecting lands 68 that extend from the upper helical edge 28 downwardly to a helical shoulder 70 of the central hub 62. The downward flow passages 20 are further defined by engagement of the lands 68 with a portion of the deflector 22. For unblocked upwardly directed flow, as the fluid flows over the top of the upper helical edge 28 and into the arcuate chamber 18, it is inverted by the arcuate chamber 18 to flow downwardly through the downward flow passages 20. Each of the helical surfaces of the collar 26 preferably has the same pitch as the internal threading 58 of the collar 26 and the external threading 46 of the base 32.

In the first preferred embodiment of the collar 26, a plurality of distribution surfaces 12 are preferably formed on an outer scalloped portion of the helical shoulder 70. As illustrated in FIGS. 3, 7, and 10, the distribution surfaces 12 are generally concave in shape. Each surface 12 includes a relatively smooth inner portion 72 and a textured outer portion 74. Moving radially outwardly, the inner portion 72 slopes relatively steeply downwardly to a nadir and, then, transitions relatively gently upwardly into the outer portion 74. The outer portion 74 preferably includes a number of drag-inducing grooves 76 about the outer periphery of the distribution surface 12. In the preferred form, each distribution surface 12 corresponds to a downward flow passage 20, and each distribution surface 12 is positioned to redirect fluid flowing through a downward flow passage 20 in a radially outwardly direction.

As can be seen in FIGS. 3, 4, 7, and 9, in the first preferred form, the collar 26 includes fins 78 and 80 (described below) to reinforce the edges of the fluid distribution arc and to reduce tangential interference as fluid is distributed radially outwardly from the nozzle 10. Strong edges to the water distribution arc are particularly desirable where there are a number of overlapping sprinklers that provide a coordinated system of irrigation. The strong edges of one sprinkler are often used to reinforce the water distribution pattern of another sprinkler. In these coordinated systems, the close-in watering of one sprinkler may be sacrificed at an edge of the water distribution arc in order to contribute to the watering of an adjacent sprinkler.

The collar 26 preferably includes a first edge surface, or fin 78, that extends axially along the underside of the collar's central hub 62. This first fin 78 reinforces a first edge of the fluid distribution arc. It reinforces this edge as fluid flows upwardly through the upward flow passages 14.

The collar 26 also preferably includes a second edge surface, or fin 80, that extends radially outwardly from the first fin 78. This second fin 80 joins the top and bottom ends of the helical shoulder 70. It reinforces the first edge of the fluid distribution arc as fluid is deflected and redirected from the distribution surfaces 12. The distribution surface 13 corresponding to this second fin 80 preferably does not include drag-inducing grooves so as not to reduce the distance of throw at the first edge of the fluid distribution arc.

There are preferably at least three flow control features on the collar 26 that reduce interference of the emerging fluid and that reduce the velocity of the bottom flow portion. First, the downward flow passages 20 include vertical side walls 79 and a wedge-shaped and sloped bottom wall 81 to contain and guide the fluid flow. Second, the collar 26 includes flow walls, or tabs 82, spaced along the helical shoulder 70 to either side of the downward flow passages 20 that act as flow guides. These flow tabs 82 guide the flow in a general radially outward direction and limit the tangential flow component, thereby providing a more uniform radial pattern. In some instances, flow tabs may be used on nozzle types of a nozzle family (i.e., each having a different throw radius) to provide a uniform pleasing aesthetic appearance and to serve as an indicator of the nozzle family. Third, the distribution surfaces 12 each include an outer scalloped portion 74 having a radial central groove 75 and other grooves that are parallel to the central groove 75. This scalloped portion 74 further increases the amount of drag on the bottom flow portion and again limits the tangential flow component.

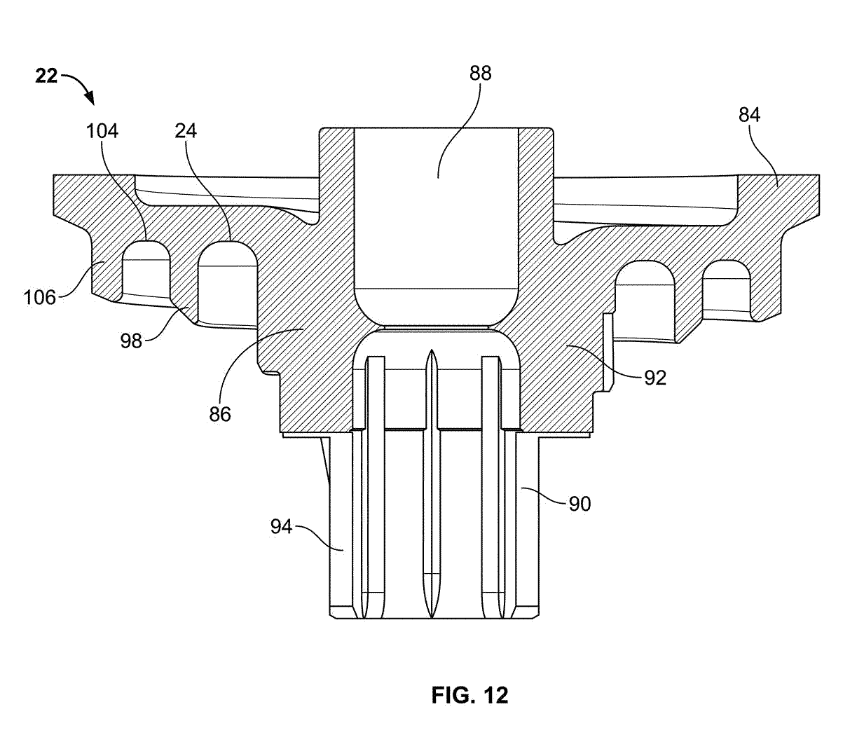

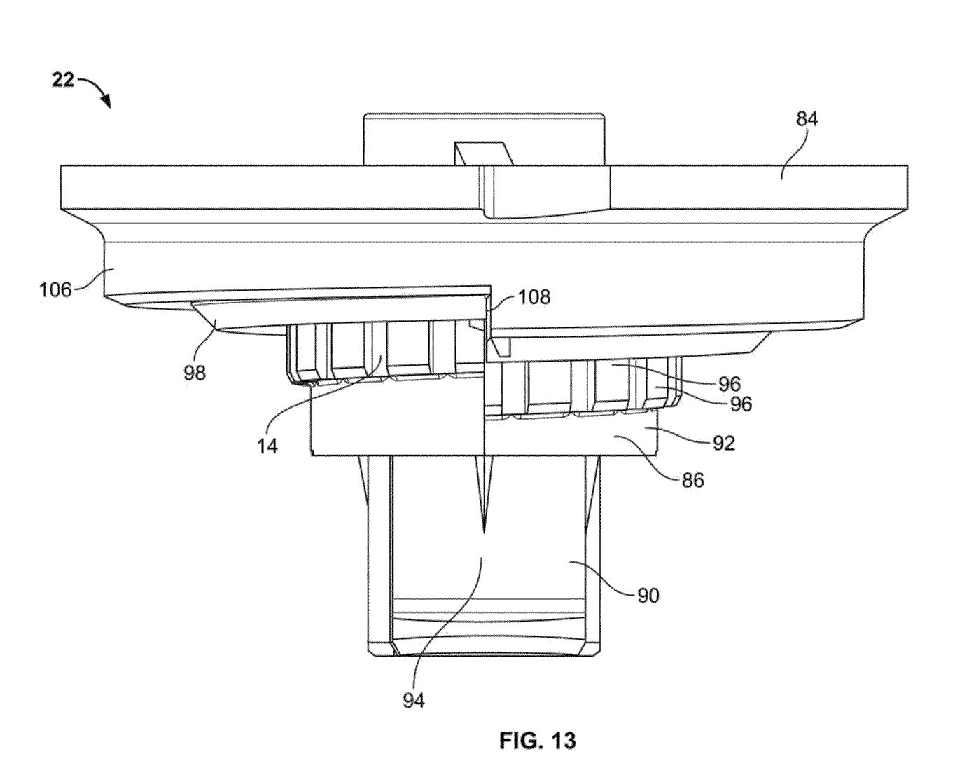

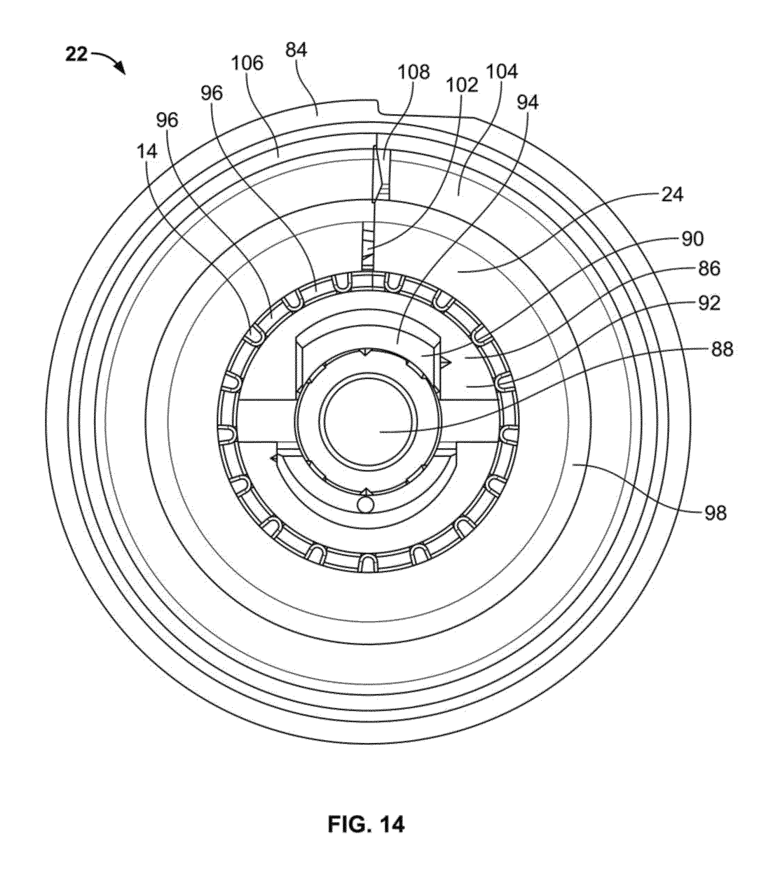

As shown in FIGS. 3, 4, and 11-14, the nozzle 10 also includes a first preferred embodiment of the deflector 22. The deflector 22 has an enlarged head 84 atop a stem 86 and defines a central bore 88 through the deflector 22 for insertion of screw 110. The stem 86 includes a lower portion 90 and an upper portion 92. During assembly, the lower portion 90 of the stem 86 is inserted through the central hubs 50 and 62 of the base 32 and collar 26, respectively. The two arms 94 of the lower stem portion 90 form a key for insertion into the base 32 and for interlocking engagement with the key-shaped, central hub 50 of the base 32. This insertion fixes the deflector 22 with respect to the base 32. In contrast, as described above, the collar 26 is rotatable with respect to the deflector 22 and the base 32, and rotation of the collar 26 allows the arcuate chamber 18 to be either increased or decreased in size to control the angle of the fluid distribution arc.

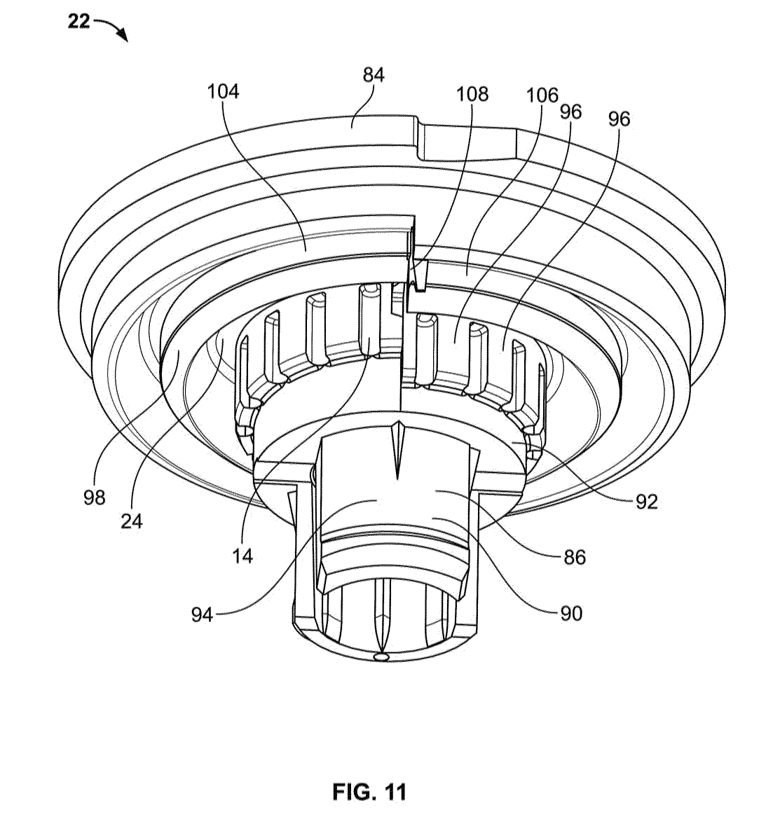

When the nozzle 10 is assembled, the stem upper portion 92 preferably engages the top of the central hub 50 of the base 32. As can be seen in FIG. 11, the stem upper portion 92 has a larger radius than the lower portion 90. The stem upper portion 92 includes a helical arrangement of upward flow passages 14 on the outer circumference thereof. Each upward flow passage 14 is defined by two outwardly projecting lands 96. For the closed portion of the helical interface 16, the upward flow passages 14 are situated below the inner helical edge 66 of the collar 26, which sealingly engages the stem 86 such that upward fluid flow is blocked. For the open portion of the helical interface 16, a portion of each upward flow passage 14 is situated above the inner helical edge 66 such that fluid can flow over the top of the upper helical edge 28 and through the downward flow passages 20.

The head 84 of the deflector 22 preferably includes an inner helical surface 24 on its underside. This inner surface 24 is preferably in the shape of a downward-facing, downward-sloping helical groove. This inner groove 24 is preferably bounded on one side by the upward flow passages 14 and on the other side by a first helical edge 98. The upper lip 28 of the collar 26 is sized to fit within this bounded region and to sealingly engage the inner groove 24. As the collar 26 is rotated, its upper lip 28 traverses the deflector's inner groove 24 to control the size of the arcuate chamber 18. In the fully open position, the collar's upper lip 28 is preferably spaced away from the deflector's inner groove 24 by one helical pitch.

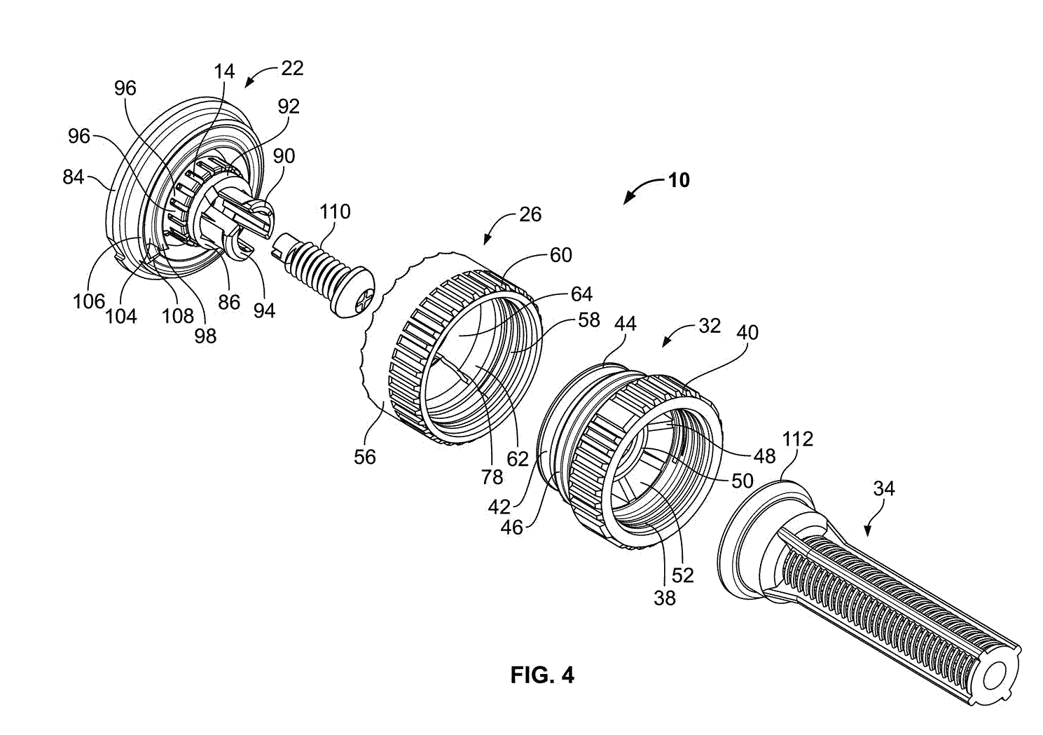

The head 84 also preferably includes an outer helical groove 104. The outer helical groove 104 is preferably bounded on one side by the first helical edge 98 and on the other side by a second helical edge 106. This outer helical groove 104 overlies the distribution surfaces 12 of the collar 26. As shown in FIGS. 4, 13, and 14, an outer edge surface, or fin 108, joins the ends of the outer helical groove 104 and defines the second edge of the fluid distribution arc. The outer fin 108 extends in a radially outward direction. The helical edges and other helical surfaces of the deflector 22 and collar 26 preferably have the same pitch as one another and as the base and collar threading 46 and 58.

The collar 26 and deflector 22 each preferably include stepped walls 101 and 102, respectively. The collar stepped wall 101 joins the ends of the upper helical lip 28, and the deflector stepped wall 102 joins the ends of the inner helical groove 24. The stepped walls 101 and 102 engage one another when the nozzle 10 is in the closed position and resist over-rotation of the collar 26 past the closed position.

The nozzle 10 also preferably includes a feature to prevent over-rotation of the collar 26 past the fully open position. In one preferred form, the threading of the base 32 and collar 26 engage to prevent over-rotation past the fully open position. The threading allows rotation of the collar 26 through one revolution, but the collar internal threading 58 has a stop 59 at one end to prevent further rotation of the collar 26.

The nozzle 10 also preferably includes a filter 34. The filter 34 has an upper lip 112 for mounting the filter 34 to the base 32 above the internal threading 38. The lip 112 may be adapted for press fit or slide fit reception onto an inner mounting surface 113 of the base 32. The filter 34 is located upstream of the upward and downward flow passages 14 and 20 of the nozzle 10 and restricts grit and other debris from flowing into the nozzle 10 and becoming lodged so as to interfere with the operation of the nozzle 10.

The nozzle 10 may also include a flow throttling screw 110 (FIGS. 1-4). The screw 110 extends through the central bore 88 of the deflector 22. One end of the screw 110 is manually adjusted to throttle the flow of fluid through the nozzle 10. The other end of the screw 110 is near an inflow port 114 defined by the filter 34. Manual rotation of the screw 110 causes the screw 110 to advance towards or move away from the inflow port 114, thereby regulating the fluid flow through the nozzle 10.

In operation, when fluid is supplied to the nozzle 10, it flows upwardly through the filter 34 and then upwardly through the flow passages defined by the ribs 52 of the base 32. Next, fluid flows upwardly through the upward flow passages 14 of the deflector 22 in a first direction generally parallel to the central axis. Fluid flowing upwardly toward the closed portion of the helical interface 16 is blocked by the sealing engagement of the collar's inner helical edge 66 with the deflector 22. Fluid flowing toward the arcuate chamber 18 flows through the upward flow passages 14 and over the top of the upper helical edge 28 and beneath a portion of the deflector 22. The arcuate chamber 18 inverts the fluid flow and redirects it downwardly through the downward flow passages 20 of the collar 26 and in a direction generally opposite the first direction. It then impacts the distribution surfaces 12 and is redirected outwardly from the nozzle 10 for irrigation. The fins 78, 80, and 108 on the deflector 22 and collar 26 reinforce fluid flow at the edges of the fluid distribution arc.

Another preferred embodiment is a method for distributing fluid from a spray nozzle, such as the preferred embodiment described above. The method generally comprises directing fluid in a first direction parallel to the central axis, directing fluid through an arcuate chamber that inverts fluid flow, directing fluid in a direction generally opposite the first direction, and directing fluid against the plurality of distribution surfaces. For example, in a preferred form, fluid is directed upwardly (first direction) through the upward flow passages 14, then is directed through the arcuate chamber 18, and then is directed downwardly (third direction) through the downward flow passages 20 and against the distribution surfaces 12.

The inverted flow approach results in an inverted velocity distribution in the fluid leaving the distribution surfaces 12, in contrast to fluid impacting an upper deflector of a conventional nozzle. The inverted fluid velocity distribution produces a more uniform distribution of fluid to surrounding terrain because high velocity fluid is in the upper region of the distribution and the lower velocity fluid is in the lower region of the distribution. Gravity does not cause the high and low velocity fluid to interfere with one another.

In conventional spray nozzles, fluid is directed upwardly against an upper deflector for deflection outward from the nozzle. The surface drag on the upper deflector results in low velocity fluid leaving the nozzle in the upper region of the distribution, and higher velocity fluid leaving the nozzle in the lower region of the distribution. Gravity then causes the lower velocity fluid to fall into the higher velocity fluid. This interference creates a compressed profile of a mid-range velocity which causes the fluid to carry over the desired watering area close to the nozzle and to fall short of the desired watering area furthest from the nozzle. As a result, a doughnut shaped distribution pattern around the nozzle is formed with fluid distributed primarily to a limited mid-range distance from the nozzle.

In contrast, the fluid deflected from the distribution surfaces 12 of the nozzle 10 does not interfere in this manner, resulting in a more uniform fluid distribution pattern. The lower velocity flow created by the drag across the distribution surfaces 12 is on the bottom portion of the distribution, whereas the higher velocity fluid is overhead and above. Thus, lower velocity fluid will not tend to interfere with the higher velocity fluid.

In addition, the outer portion 74 of each distribution surface 12 is formed with grooves 76 to increase the frictional drag on the fluid across the distribution surfaces 12. This drag further reduces the velocity of the fluid at the bottom of the distribution leaving the distribution surfaces 12. This reduced velocity enhances the fluid distribution for the area closer to the nozzle 10, while allowing the higher velocity fluid to reach the outermost area intended for irrigation.

The characteristics of the fluid distribution may be tailored by changing certain aspects of the nozzle 10. For example, the number and arrangement of the upward and downward flow passages 14 and 20 may be modified. There need not be a one-to-one correspondence of upward flow passages 14 to downward flow passages 20. In addition, the number and arrangement of grooves 76, or other alternative surface features, may be modified to increase or decrease the frictional drag across the distribution surfaces 12 and to thereby increase or decrease the velocity of some portion of the fluid distribution.

Moreover, the flow characteristics of the fluid emitted from the nozzle 10 may be modified for different nozzle types by changing certain dimensions of the nozzle 10, such as, for example, the cross-sectional dimensions of the upward and downward flow passages 14 and 20. The cross-sectional area of the upward flow passages 14 may be different than that of the downward flow passages 20. The ratio of these cross-sectional areas may be adjusted to achieve desirable fluid pressure and velocity values at the distribution surfaces 12 of the collar 26.

Further, the upward and downward flow passages 14 and 20 can be substantially larger in diameter than a single orifice (such as that used in a conventional up flow nozzle). The cross-section of the upward and downward flow passages 14 and 20 are preferably selected large enough to reduce the likelihood of clogging. For nozzles with passages in series, the ratio of the passage size affects pressure and exit velocity characteristics. For nozzles with flow passages having a uniform cross-section, in contrast, these characteristics may require that the flow passage be very small. Accordingly, the use of relatively large passages in series reduces the sensitivity of nozzles to clogging with contamination that would otherwise occur in conventional nozzles employing a relatively small flow passage.

As can be seen from FIGS. 7, 9, 11, and 13, the upward and downward flow passages 14 and 20 are preferably formed as notches between sets of projecting lands 68 and 96, respectively. The use of such notches 14 and 20 allows proportioning of fluid flow to prevent a fluid precipitation rate that varies depending on the size of the arc selected by the user. In other words, the use of notches 14 and 20 provides a relatively constant precipitation rate for the nozzle, regardless of the arc selected.

In addition, the use of notches for the upward and downward flow passages 14 and 20 allows for the matching of precipitation rates for a family of nozzles in which each nozzle has a different maximum throw radius. One can achieve such a matched precipitation rate by designing each nozzle type with a different number, arrangement, and/or cross-section of upward flow passages 14 with respect to downward flow passages 20 than other nozzle types. As stated above, this modification of the relationship of upward to downward flow passages allows for fine tuning of velocity and pressure characteristics at the distribution surfaces. Accordingly, by modifying the relationship between the upward and downward flow passages 14 and 20 for each nozzle type, a matched precipitation rate can be achieved for the family of nozzles.

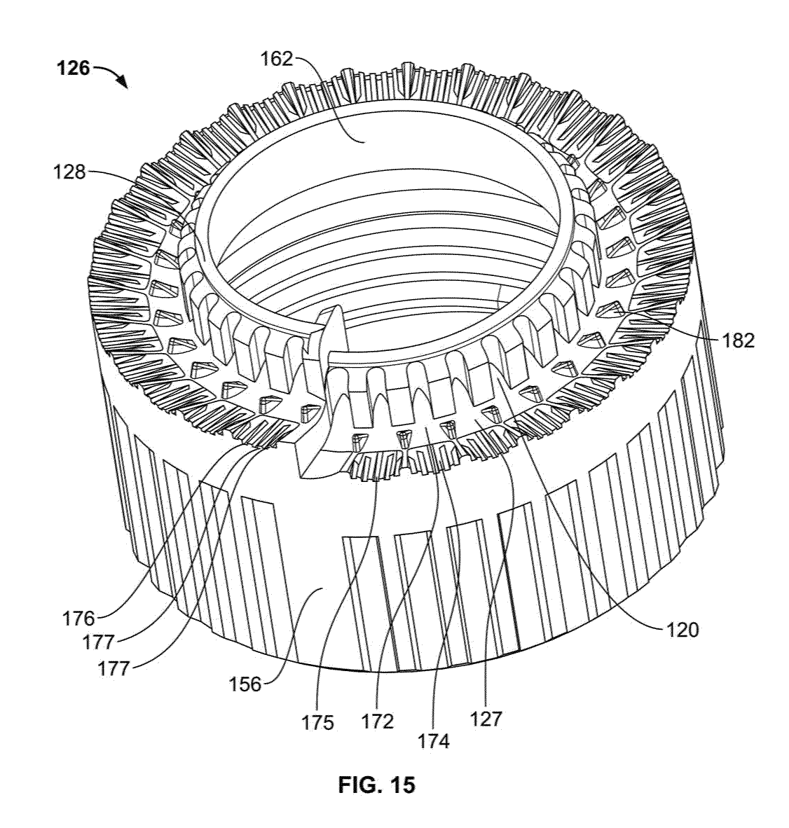

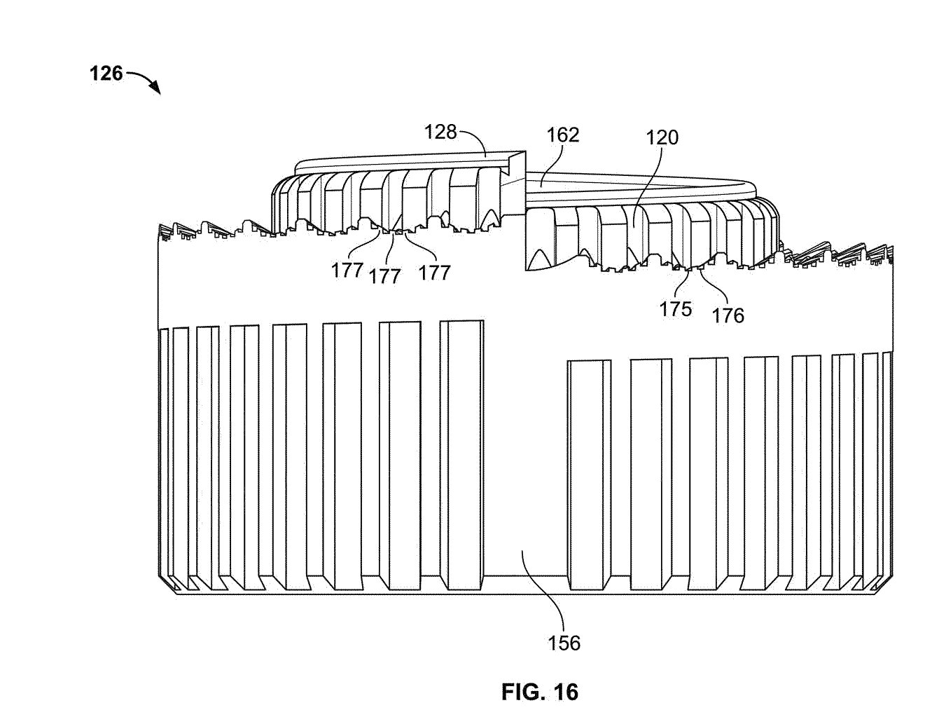

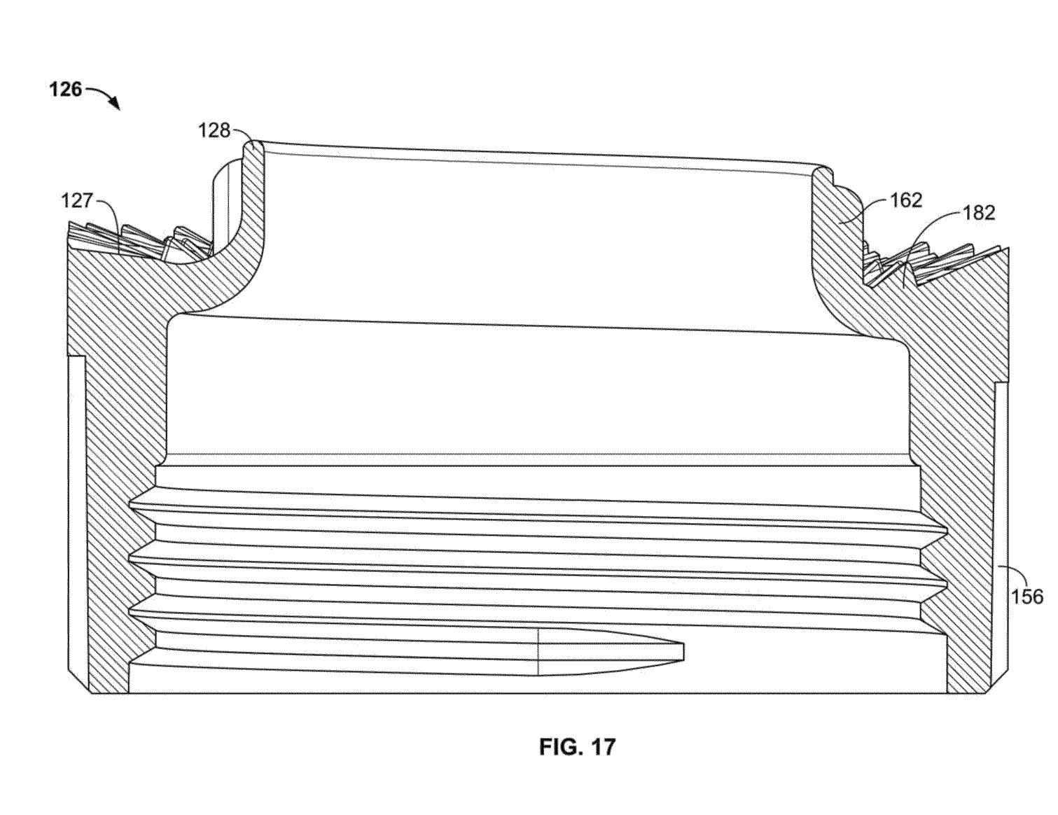

FIGS. 1-14 show a nozzle 10 using one preferred form of collar 26, but other preferred embodiments of the collar may also be used and are shown in FIGS. 15-24. A second preferred embodiment of the collar (collar 126) is shown in FIGS. 15-17. The collar 126 is generally similar in shape to collar 26 described above and includes an outer wall 156 for adjusting the arcuate setting, central hub 162, upper helical edge 128, downward flow passages 120, and distribution surfaces 127. As can be seen in FIG. 17, however, the collar 126 does not include an inner helical edge because it is intended for use with a corresponding deflector (such as deflector 622 or 722 described below) that does not include upward flow passages. Fluid flow is generally the same as with collar 26. Fluid flows upwardly toward the top of the open portion of the upper helical edge 128, into an arcuate chamber formed by collar 126 and a deflector, is inverted, and flows downwardly through downward flow passages 120 onto distribution surfaces 127.

In the second preferred embodiment, the distribution surfaces 127 are arranged in generally the same manner as the first embodiment. Each surface 127 includes a relatively smooth inner portion 172 and a textured outer portion 174 with flow tabs 182 spaced to either side of the distribution surfaces 127. The textured outer portion 174 preferably includes a number of drag-inducing grooves 176, preferably with a central radial groove 175 and additional grooves parallel to the central groove 175. In the second preferred embodiment, however, the shape of the textured outer portion 174 has been modified. More specifically, the grooves 176 are separated from one another by upwardly projecting ridges 177. The ridges 177 provide greater friction that significantly decreases the velocity of the bottom part of the water distribution, thereby improving close-in irrigation of surrounding terrain. Thus, these ridges 177 may be especially advantageous for nozzle types with a longer throw radius.

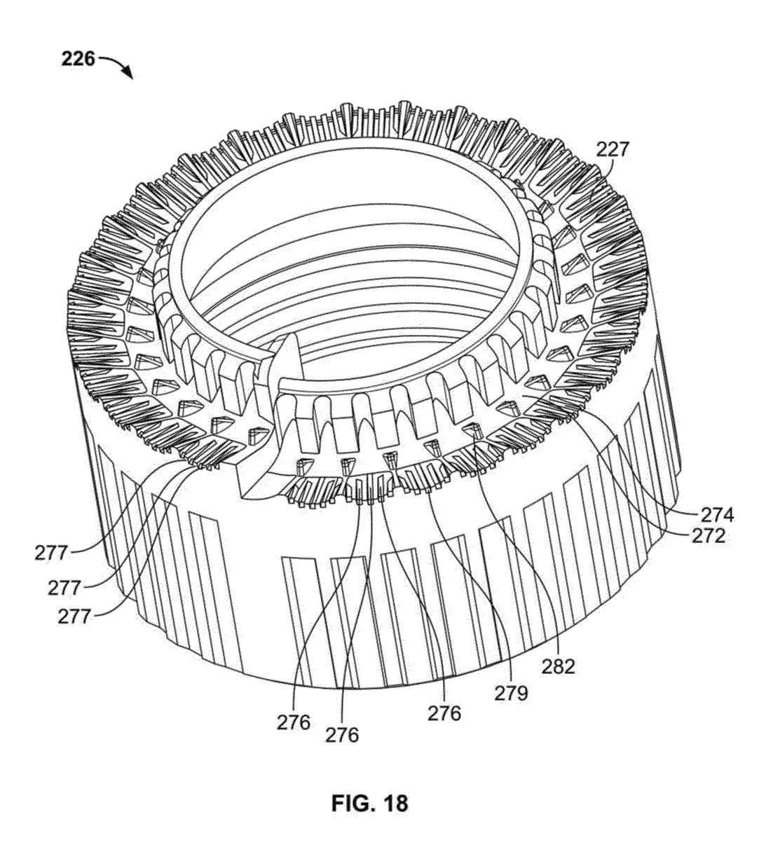

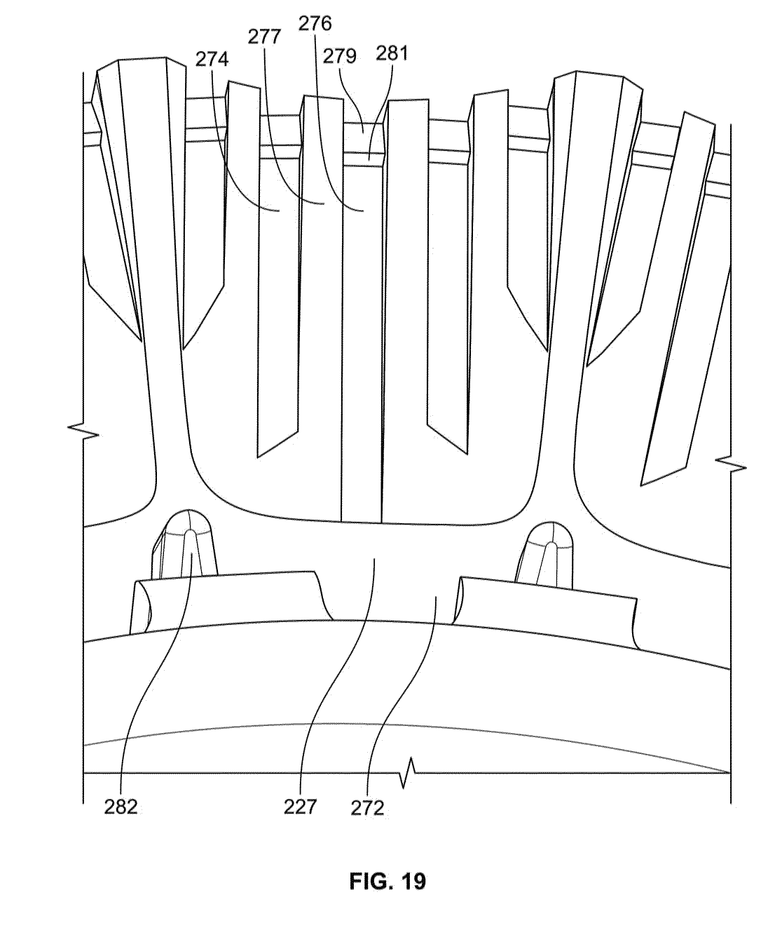

A third preferred form of the collar (collar 226) is shown in FIGS. 18-19 and is generally similar in structure and operation to the second embodiment described above. Again, the collar 226 includes distribution surfaces 227 with each surface 227 having a relatively smooth inner portion 272, a textured outer portion 274, and with flow tabs 282 spaced to either side of the distribution surfaces 227. As in the second embodiment, the textured outer portion 274 includes grooves 276 that are separated from one another by upwardly projecting ridges 277. In the third preferred embodiment, however, the textured outer portion 274 has been modified to provide even greater friction. More specifically, the grooves 276 each terminate in a stop 279 at the very outer portion thereof. Each stop 279 forms a wall 281 that is impacted by fluid flowing in the groove 276 and that then slopes in a downward direction as one proceeds radially outward. These stops 279 further reduce the velocity of the bottom part of the water distribution, thereby further improving close-in irrigation of surrounding terrain.

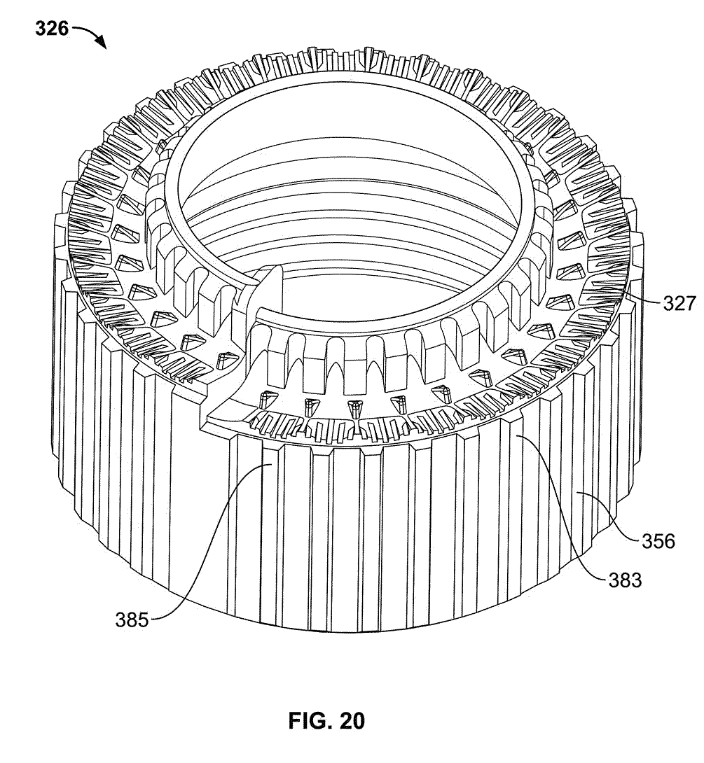

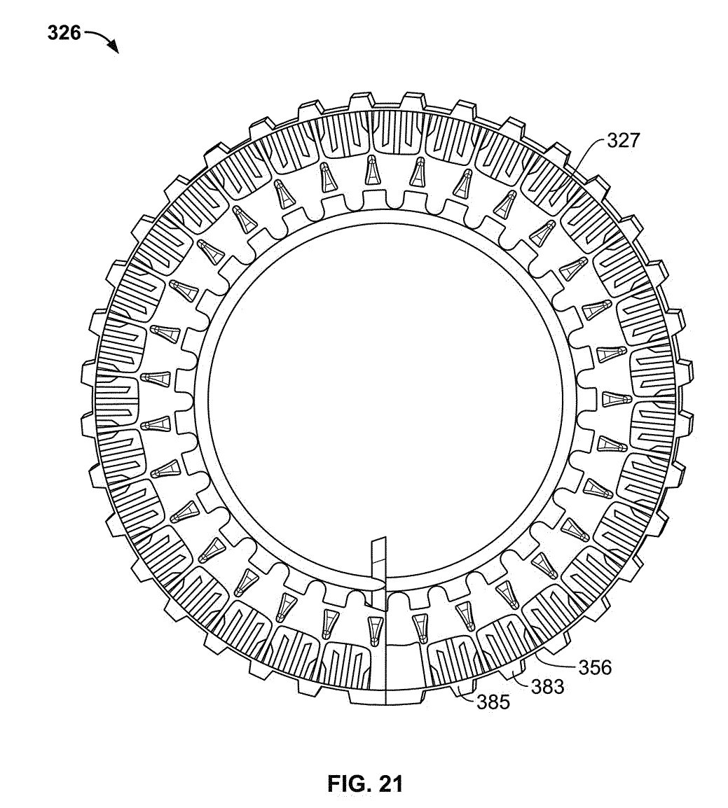

A fourth preferred form of the collar (collar 326) is shown in FIGS. 20-21 and is generally similar in structure and operation to the second embodiment described above. The collar 326, however, has been modified to prevent debris intrusion or vegetation intrusion into the nozzle. More specifically, the collar 326 has a knurled surface 383 made of external ribs 385 extending radially outwardly from the outer wall 356 and that extend axially to just beneath the distribution surfaces 327. These ribs 385 limit the entry of debris and vegetation into the gap defined by the distribution surfaces 327 and the second helical edge of a deflector. This collar 326 is preferably used in conjunction with the deflector 722 (described below), which also acts to limit debris and vegetation intrusion.

A fifth preferred embodiment (collar 426) is shown in FIG. 22. The collar 426 is generally similar in shape to collar 126 and includes an outer wall 456, central hub 462, and upper helical edge 428, and does not include an inner helical edge. Unlike the second embodiment, however, the collar 426 does not include any individual downward flow passages. Fluid flow is similar as with collar 126 but does not involve downward flow passages. The absence of downward flow passages may be desirable for nozzle types with a relatively long throw radius. Fluid flows upwardly toward the top of the open portion of the upper helical edge 428, into an arcuate chamber, is inverted, and flows downwardly onto helical shoulder 470.

The collar 426 also does not include individual scalloped distribution surfaces like those shown in the second embodiment, which assisted in guiding fluid flowing through the downward flow passages. Instead, the helical shoulder 470, in effect, forms one continuous distribution surface. It includes a relatively smooth inner portion 472 and a generally textured outer portion 474 with flow tabs 482 spaced helically at predetermined intervals along the helical shoulder 470. The textured outer portion 474 is preferably made of radial grooves 476 of roughly the same length that extend along most of the helical shoulder 470. The grooves 476 are relatively long and preferably extend the radial distance between the flow tabs 482 and the outer wall 456. The grooves 476 are preferably separated from one another by upwardly projecting ridges 477 to improve close-in water distribution. Fluid flows generally downwardly along the outside of the central hub 462, between flow tabs 482, and along the textured outer portion 474. The textured outer portion 474 preferably includes a smooth scallop 487 without grooves at the lower end of the helical shoulder 470 to reduce friction and to provide a strong water stream at the first edge of the water distribution arc.

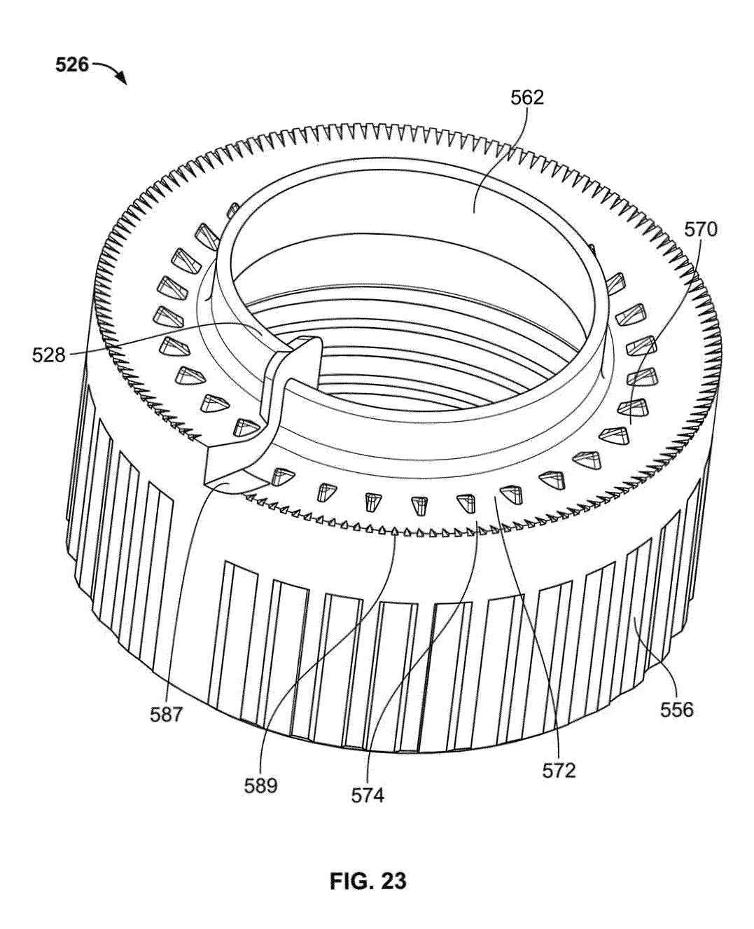

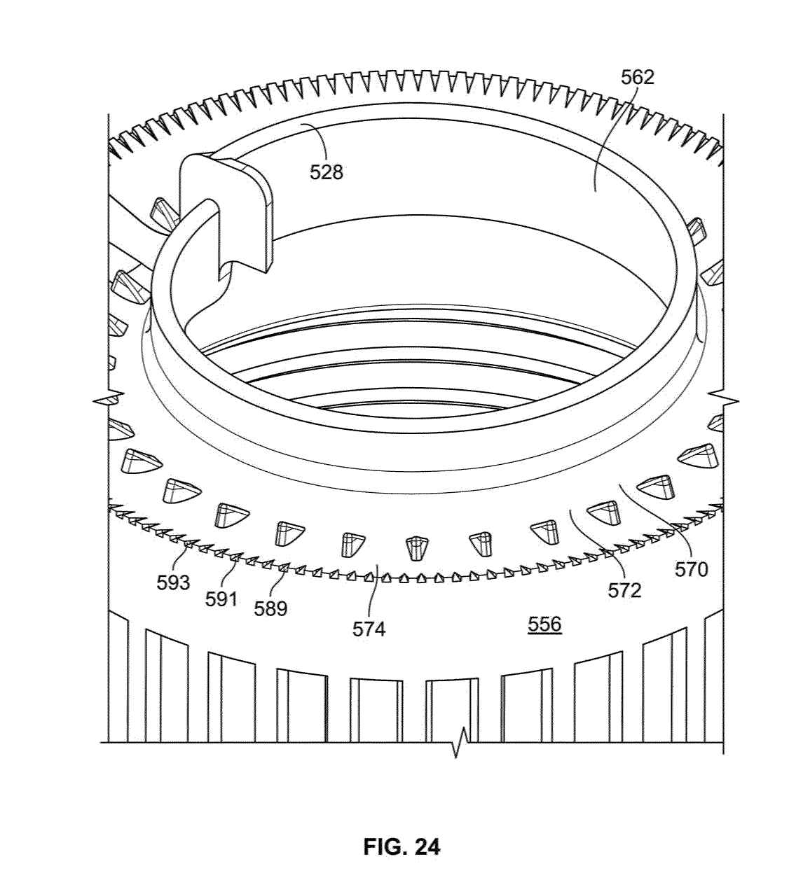

A sixth preferred embodiment of the collar (collar 526) is shown in FIGS. 23-24. The collar 526 is similar in structure to collar 426. It includes an outer wall 556, central hub 562, and upper helical edge 528, but does not include an inner helical edge, any individual downward flow passages, or any individual scalloped distribution surfaces. Like the fifth embodiment, the collar 526 has a helical shoulder 570 without scalloped distribution surfaces. Unlike the fifth embodiment, however, most of the helical shoulder 570 is relatively smooth and does not include relatively long radial grooves.

The shoulder 570 includes a relatively smooth inner portion 572, flow tabs 582 spaced helically at predetermined intervals along the helical shoulder 570, and a relatively smooth outer portion 574 terminating in inlet ducts 589 spaced helically about the outer periphery. The inlet ducts 589 each generally include a shallow ramp 591 with curved walls 593 recessed into the helical shoulder 570 in order to draw fluid into each duct 589. More specifically, the ramp angle and the curvature profile of the walls 593 are selected to create counter-rotating vortices that trap a boundary water layer by deflecting this layer away from the duct 589 while simultaneously drawing in faster moving fluid. As a result of this swirling effect, the inlet duct 589 reduces boundary layer fluid velocity and increases close-in water distribution. The collar 526 also preferably includes a smooth scallop 587 at the lower end of the helical shoulder 570 to provide a strong water stream at the first edge of the water distribution arc.

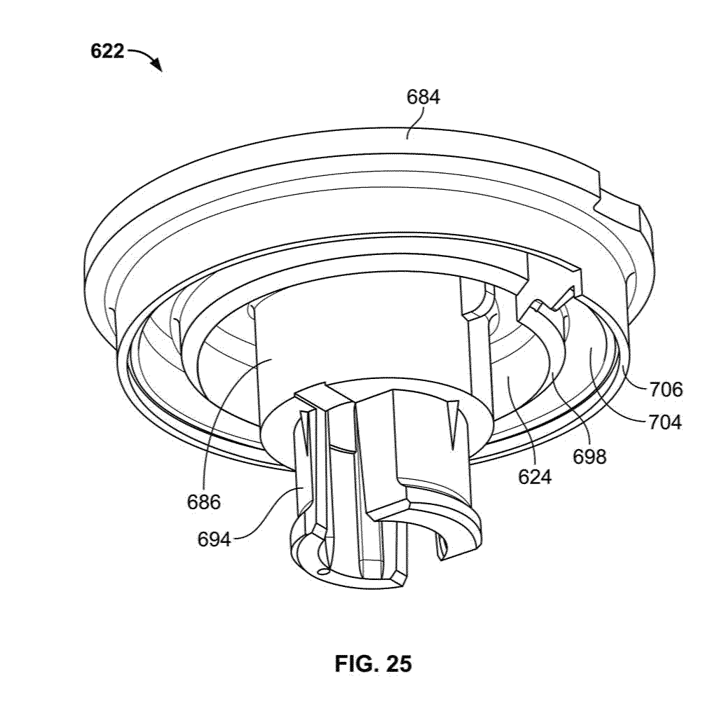

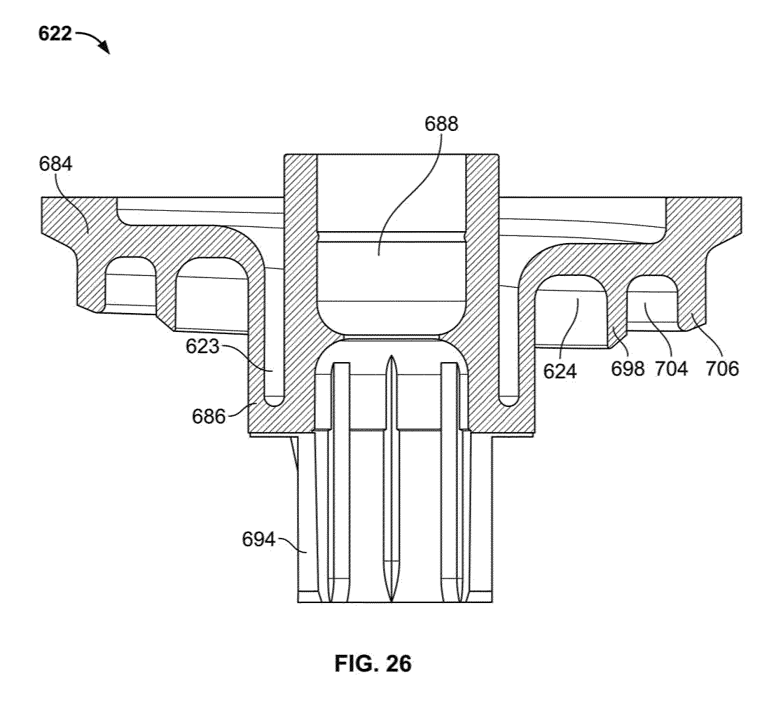

As with the collar, other preferred embodiments of the deflector may also be used and are shown in FIGS. 25-28. A second embodiment of the deflector (deflector 622) is shown in FIGS. 25-26. The deflector 622 is generally similar in shape to deflector 22 described above and includes an enlarged head 684, a stem 686, a central bore 688, arms 694, but, as can be seen, the stem 686 does not include any notches defining upward flow passages, which may be desirable for nozzle types with a relatively long throw radius. The deflector 622 also preferably includes helical surfaces like those of the deflector 22, including inner helical surface 624, first helical edge 698, outer helical surface 704, and second helical edge 706. The deflector 622 may optionally include a hollow circumferential region 623 formed in the top surface of the head 684 and about the bore 688. Fluid flow is generally the same as for deflector 22 but without the individual upward flow passages. Fluid flows upwardly adjacent the stem 686 (but not through notches defining individual upward flow passages), into an arcuate chamber formed by the deflector 622 and a collar, is inverted, and flows downwardly onto distribution surfaces of a collar.

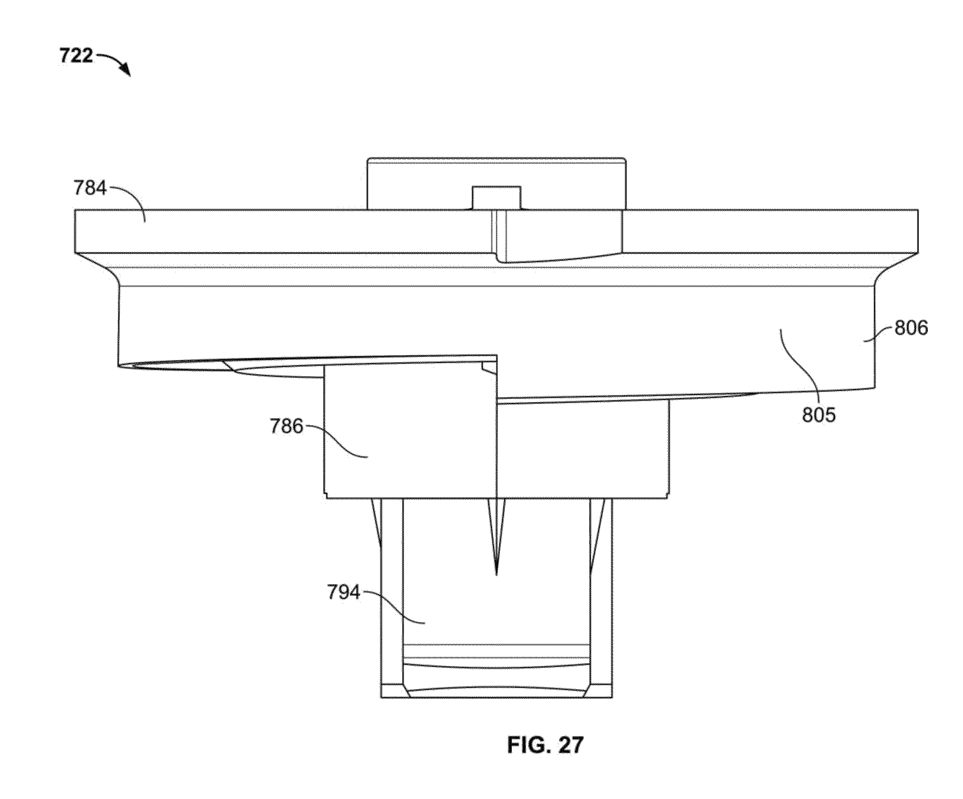

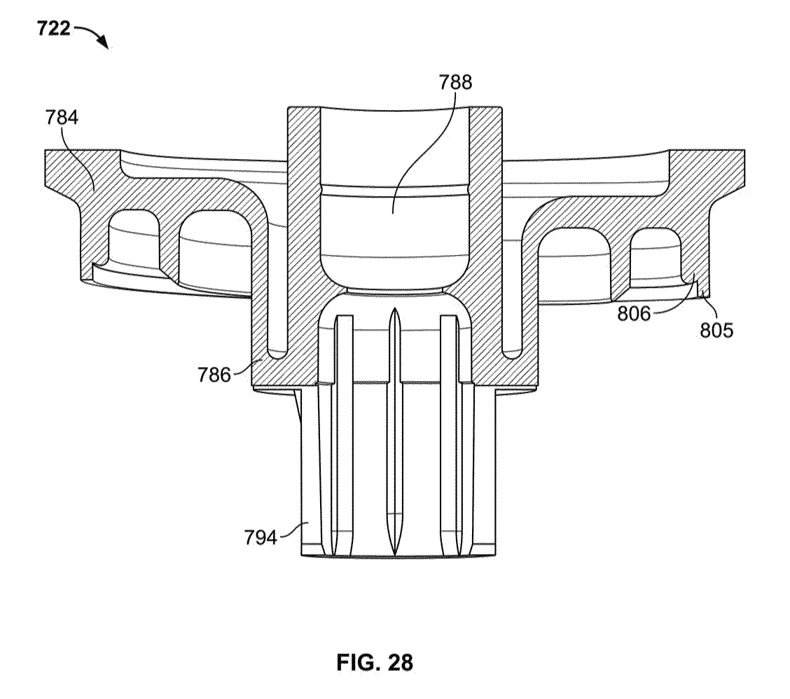

A third preferred form of the deflector (deflector 722) is shown in FIGS. 27-28 and is generally similar in structure and operation to the second embodiment described above. It includes the head 784, stem 786, central bore 788, arms 794, and helical surfaces described above, but does not include notches that define upward flow passages. As can be seen in FIG. 28, the deflector 722 includes a downwardly projecting outer wall 805 on the second helical edge 806. This outer wall 805 forms a protective lip that limits the intrusion of debris or vegetation into the nozzle. More specifically, the outer wall 805 provides protection from intrusion into the gap defined by the second helical edge 806 and distribution surfaces of a collar.

In general, any of the preferred forms of the deflector may be used interchangeably with the various preferred forms of the collar described herein. The forms of the deflector and collar may be selected to provide desired features and advantages and to achieve desired velocity and pressure characteristics for irrigation. The structure and description of the deflector 22 and collar 26 generally apply equally to the other preferred embodiments of deflector and collar described herein, except where noted herein.

The foregoing relates to preferred exemplary embodiments of the invention. It is understood that other embodiments and variants are possible which lie within the spirit and scope of the invention as set forth in the following claims.

What is claimed is:

1. A spray nozzle comprising:
a first nozzle body having a first helical surface;
a second nozzle body being rotatably associated with the first nozzle body and having a second helical surface and at least one distribution surface to deflect fluid for discharge from the nozzle, and the first and second helical surfaces cooperating to define an adjustable arcuate chamber upon rotation of the second nozzle body; and
a flow path defined at least in part by the first nozzle body and the second nozzle body to convert flow from a first direction to a generally opposite direction and towards the at least one distribution surface.

2. The spray nozzle of claim 1 wherein the first nozzle body defines a first plurality of flow passages and the second nozzle body defines a second plurality of flow passages.

3. The spray nozzle of claim 2 wherein the flow path is defined to direct fluid flow through the first plurality of flow passages in the first direction, through the arcuate chamber, and through the second plurality of flow passages in the opposite direction to the at least one distribution surface, and radially outwardly through a predetermined arc.

4. The spray nozzle of claim 3 wherein the first direction is an upward direction and the opposite direction is a downward direction.

5. The spray nozzle of claim 3 wherein the at least one distribution surface is positioned to deflect fluid radially outwardly in the predetermined arc with a fluid distribution having a top portion with a substantially uniform distribution radius and having a bottom portion for close-in fluid distribution, the top portion having a first velocity and the bottom portion having a second velocity and the first velocity being greater than the second velocity.

6. The spray nozzle of claim 1 wherein the first helical surface is a groove and wherein the second helical surface is a lip adapted to be received within the groove.

7. The spray nozzle of claim 2 wherein the first nozzle body comprises a head joined to a stem, the head defining the first helical surface and the stem defining the first plurality of flow passages.

8. The spray nozzle of claim 2 wherein the first helical surface defines a central axis and wherein the first plurality of flow passages is spaced on the first nozzle body helically about the central axis.

9. The spray nozzle of claim 1 wherein the first nozzle body further comprises a central bore for insertion of a flow rate adjustment screw therethrough.

10. The spray nozzle of claim 1 wherein the second nozzle body further comprises an inner helical edge defining a central bore, the inner helical edge engaging the first nozzle body to adjustably restrict fluid flow through the arcuate chamber.

11. The spray nozzle of claim 2 wherein the at least one distribution surface comprises a plurality of distribution surfaces, each of the second plurality of flow passages corresponding to one of the plurality of distribution surfaces and each of the second plurality of flow passages configured to direct fluid flow against each corresponding distribution surface.

12. The spray nozzle of claim 11 wherein the second helical surface defines a central axis and wherein the second plurality of flow passages and the distribution surfaces are spaced helically on the second nozzle body about the central axis.

13. The spray nozzle of claim 1 wherein at least one of the distribution surfaces has an uneven surface profile to increase frictional drag to reduce the velocity of fluid flow discharged from the nozzle.

14. The spray nozzle of claim 13 wherein the second nozzle body comprises a third helical surface defining the at least one distribution surface.

15. The spray nozzle of claim 14 wherein the at least one distribution surface comprises a plurality of concave distribution surfaces formed along the third helical surface.

16. The spray nozzle of claim 13 wherein one or more of the distribution surfaces has a grooved surface.

17. The spray nozzle of claim 13 further comprising a plurality of flow walls spaced along the at least one distribution surface and guiding fluid flow radially outward.

18. The spray nozzle of claim 13 wherein the uneven surface profile comprises a plurality of grooves, each groove separated from another by a ridge projecting away from the at least one distribution surface and increasing the frictional drag.

19. The spray nozzle of claim 18 wherein the at least one distribution surface comprises an outer portion, each groove terminating in a stop at the outer portion for increasing frictional drag.

20. The spray nozzle of claim 14 wherein the third helical surface comprises an outer portion that defines a plurality of grooves extending in a radial direction along the third helical surface for increasing frictional drag.

21. The spray nozzle of claim 13 wherein the at least one distribution surface comprises an outer portion that defines a plurality of inlet ducts for increasing frictional drag, one or more inlet ducts comprising an inclined ramp with curved walls recessed into the at least one distribution surface, the ramp angle and the curvature of the walls selected to create at least one vortex in the fluid flow.

22. The spray nozzle of claim 1 further comprising a third nozzle body that is adapted to fixedly engage the first nozzle body to resist rotation of the first nozzle body and to rotatably engage the second nozzle body to allow rotation of the second nozzle body.

23. The spray nozzle of claim 22 wherein the first nozzle body comprises a stem and the third nozzle body comprises a central hub defining a central bore, the stem adapted for fixed insertion into the central bore.

24. The spray nozzle of claim 23 wherein the third nozzle body comprises an outer wall and ribs connecting the outer wall to the central hub, the ribs defining flow passages therebetween.

25. The spray nozzle of claim 24 wherein the third nozzle body further comprises an inner mounting surface for mounting a filter.

26. The spray nozzle of claim 1 wherein the first nozzle body includes a first edge surface to channel fluid flow and define a first edge of the discharged fluid and the second nozzle body includes a second edge surface to channel fluid flow and define a second edge of the discharged fluid.

27. The spray nozzle of claim 26 wherein the second nozzle body further comprises a third edge surface to channel fluid flow and define the second edge of the discharged fluid, the first and second edge surfaces extending in a radial direction and the third edge surface extending in an axial direction.

28. The spray nozzle of claim 2 wherein the first and second helical surfaces define a common central axis, the first plurality of flow passages are notches spaced helically about the central axis on the first nozzle body, and the second plurality of flow passages are notches spaced helically about the central axis on the second nozzle body.

29. The spray nozzle of claim 2 wherein the first plurality of flow passages comprises a first predetermined number of flow passages and the second plurality of flow passages comprises a second predetermined number of flow passages, the first and second predetermined numbers being selected to yield a predetermined fluid precipitation rate for the spray nozzle.

30. The spray nozzle of claim 2 wherein the first plurality of flow passages each have a first cross-sectional area and the second plurality of flow passages each have a second cross-sectional area, the first and second cross-sectional areas being selected to yield a predetermined fluid precipitation rate for the spray nozzle.

31. The spray nozzle of claim 2 wherein the first plurality of flow passages are in series with the second plurality of flow passages.

32. The spray nozzle of claim 1 wherein the second nozzle body includes a central axis and an outer wall with external ribs extending in an axial direction along the wall to limit intrusion of debris onto the at least one distribution surface.

33. The spray nozzle of claim 1 wherein the first nozzle body includes a central axis and an outer wall with a lip projecting in an axial direction to limit intrusion of debris onto the at least one distribution surface.

34. A spray nozzle comprising:
a nozzle body having a central axis and comprising a first nozzle body portion and a second nozzle body portion;
the first nozzle body portion defining a first plurality of flow passages and having a first helical surface;
the second nozzle body portion rotatable about the central axis and defining a second plurality of flow passages, at least one distribution surface, and a second helical surface for rotatably engaging the first helical surface to form an arcuate chamber that is adjustable in size to determine an arc of fluid distribution; and
a flow path from the first plurality of flow passages through the arcuate chamber through the second plurality of flow passages to the at least one distribution surface and radially outwardly through the predetermined arc.

35. The spray nozzle of claim 34 wherein the flow path through each of the first plurality of flow passages is in a first direction parallel to the central axis and wherein the flow path through each of the second plurality of flow passages is in a direction generally opposite the first direction.

36. The spray nozzle of claim 34 wherein the at least one distribution surface is positioned to deflect fluid radially outwardly in the predetermined arc with the fluid distribution having a first velocity at a top portion of the distribution and having a second velocity at a bottom portion of the distribution, the first velocity being greater than the second velocity such that fluid having the first velocity does not intermingle with fluid having the second velocity.

37. The spray nozzle of claim 34 wherein the first helical surface is a groove and wherein the second helical surface is a lip adapted to be received within the groove.

38. The spray nozzle of claim 34 wherein the first plurality of flow passages are notches spaced helically about the central axis on the first nozzle body portion and the second plurality of flow passages are notches spaced helically about the central axis on the second nozzle body portion.

39. A method for distributing fluid from a spray nozzle, the nozzle having a first nozzle body defining a first helical surface, a second nozzle body defining a second helical surface and at least one distribution surface, and the first and second helical surfaces cooperating to define an adjustable arcuate chamber upon rotation of the second nozzle body, the method comprising:
directing fluid through a portion of the first nozzle body in a first direction parallel to the central axis;
directing fluid into the arcuate chamber and inverting the flow;
directing fluid through a portion of the second nozzle body in a direction generally opposite the first direction; and
directing fluid against the at least one distribution surface.

40. The method of claim 39 wherein the first direction is an upward direction and the opposite direction is a downward direction.
